(19) United States
(12) Patent Application Publication
(10) Pub. No.: US 2009/0064956 A1
(43) Pub. Date: Mar. 12, 2009

(54) Ashless Consumable Engine Oil

(75) Inventor: Ewa Bardasz, Mentor, OH (US)

Correspondence Address: THE LUBRIZOL CORPORATION;ATTN: DOCKET CLERK, PATENT DEPT., 29400 LAKELAND BLVD., WICKLIFFE, OH, 44092, US

(73) Assignee: The Lubrizol Corporation, Wickliffe, OH (US)

(21) Appl. No.: 12/272,920

(22) Filed: Nov. 18, 2008

Related U.S. Application Data
(62) Division of application No. 10/972,621, filed on Oct. 25, 2004.

(51) Int. Cl. F02M 25/00; C10M 133/44

(52) U.S. Cl. 123/1 A; 508/287

(57) ABSTRACT

The present invention relates to a low sulfur, low phosphorus, low-ash, zinc free consumable lubricant composition suitable for use in an internal combustion engine, comprising: an oil of lubricating viscosity containing less than 0.01 percent by weight of sulfur; a high TBN succinimide dispersant and overall all lubricant composition that has a sulfated ash value of up to about 0.2, a phosphorus content of up to about 50 to about 800 ppm and a sulfur content of up to about 0.4 percent by weight.

### BACKGROUND OF THE INVENTION

The present invention relates to a low sulfur, low phosphorus, low-ash consumable lubricant composition suitable for use in an internal combustion engine.

Over the last twenty years, engine manufactures have achieved remarkable reductions in Particulate Matter (PM) emissions by significant modifications of their engines. One of the most innovative recent approaches includes the introduction of highly advanced, hydraulic or non-hydraulic, electromagnetic actuated electronic controls that eliminates mechanically driven camshafts. There is now a need to lubricate these new engines, while maintaining the reduction in PM emissions. The present invention of a low sulfur, low phosphorus, low-ash consumable lubricant fulfills these requirement.

Another problem associated with internal combustion engines equipped with exhaust gas after-treatment devices (e.g., catalytic converters, particulate traps, catalyzed traps, etc.) is that the lubricating oils for such engines are used in both the crankcase as well as in high wear areas such as the valve train. Because these oils are used in high wear areas they usually contain extreme pressure (EP) agents which typically contain metal (e.g., zinc) and phosphorus in order to be effective. During the operation of the engine these EP agents decompose and the resulting decomposition products eventually enter the aftertreatment device resulting in damage to the device. The problem therefore is to provide a lubricating oil composition that avoids damaging the exhaust gas aftertreatment device. Because of the present invention's absence of high levels of EP agents containing metal and phosphorus the exhaust gas aftertreatment device is protected from such harmful exposure which can destroy the exhaust gas aftertreatment device.

Another problem associated with conventional internal combustion engines is that the time interval required between oil changes typically is less than the time interval required for other service items such as air filter replacements, coolant changes, brake replacements, and the like. Oil changes are viewed as one of the most aggravating and, in some cases, most costly maintenance aspects of vehicle ownership. Traditionally, oil change intervals have been extended by base stock and additive upgrades. Since the 1920s, for example, the extensions have been about 15× or greater. Regardless of this progress, the time intervals required between oil changes continue to be shorter than behind the time intervals required for other service items. The problem therefore is to improve the lubricant technology for these engines so that the time intervals between oil changes can be extended to coincide with other service intervals. In accordance with the inventive method, the required oil change intervals are extended due to the fact that during operation of the engine, used engine oil is continuously or periodically removed from the engine and replaced with new oil.

Another problem associated with the operation of internal combustion engines is that the exhaust gases from such engines contain NOx which is an undesirable pollutant. It would be advantageous if the level of NOx in the exhaust gases of internal combustion engines could be reduced. The present invention may assist in reducing the levels of NOx in the exhaust gas because the invention is less harmful to NOx emissions reducing catalyst.

Another problem associated with the operation of internal combustion engines is the disposal of conventional lubricating oils. An advantage of the inventive low-sulfur, low phosphorus, low-ash consumable lubricating oil compositions is that these oil compositions may be easier to dispose of from an environmental perspective than conventional lubricating oils. This is due to the absence of EP agents containing metal, sulfur and phosphorus in these lubricating oil compositions. Conventional lubricating oil compositions typically contain relatively high concentrations of such EP additives.

U.S. Pat. No. 6,588,393 discloses a low-sulfur consumable lubricating oil composition which comprises a synthetic base lubricating oil and from about 1% to about 25% by weight of an acylated nitrogen-containing compound having a substituent of at least about 10 aliphatic carbon atoms. The sulfur content of this consumable lubricating oil is about 5 to about 250 parts per million.

U.S. Pat. No. 5,955,403 discloses a sulfur free lubricating oil composition which comprises a major portion of a synthetic base lubricating oil and a minor portion of a tri(alkyl phenyl) phosphate or di(alkylphenyl) phosphoric acid antiwear agent, an amine antioxidant a substituted succinamide rust inhibitor, and a tolyltriazole. The tri(alkylphenyl)phosphate antiwear agent is incorporated in the oil in an amount ranging between about 0.1 to 2.0 wt % and the amine antioxidant in amount ranging from about 0. 1 to 5 wt %. The succinamide is present in an amount ranging from about 0.01 to 0.5 wt %, and the tolyltriazole from about 0.01 to 0.5 wt %.

U.S. Pat. No. 4,392,463 discloses a diesel engine having a first lubrication system, containing conventional engine oil, used to lubricate that section of the engine subjected to excessive wear, the valve train including the cam shaft, valve lifters, rocker arm, valve stems, etc., and a second lubricant system, utilizing diesel fuel, for lubricating the remaining section of the engine—the crankshaft and associated parts, pistons, connecting rods, etc. By being exposed to crankcase blow—by exhaust gases, diesel fuel used to lubricate the crankshaft, absorbs pollutants and contaminants contained therein and recirculates these contaminants through the fuel system to be burned and exhausted. By constantly being lubricated with fresh lubricant, wear on these specific parts is reduced. The reference indicates that frequent lubrication changes have been eliminated because the diesel fuel/lubricant is continuously changed and circulated through the fuel system. Since the engine oil and the first lubrication system is not exposed to crankcase blow by exhausted gases, its useful life is prolonged, thus reducing the frequency of required oil changes

### SUMMARY OF THE INVENTION

The present invention provides formulations and a method suitable for lubricating an internal combustion engine, comprising:

A low-sulfur, low-phosphorus, low-ash consumable composition suitable for use in an internal combustion engine, comprising:

(a) an oil of lubricating viscosity, and

(b) a succinimide dispersant with a TBN of at least 80 on a diluent-free basis, in an amount sufficient to provide at least 8 TBN to the combination of (a) and (b);

wherein said combination of (a) and (b) has a zinc content of 0 to 0.07 percent by weight and has a percent sulfated ash value of up to 0.2, a phosphorus content of 50 to 800 ppm and a sulfur content of up to 0.4 percent by weight;

further comprising (c) a diesel fuel having a sulfur content of 0 to 50 ppm.

The present invention further provides a method for lubricating an internal combustion engine, comprising:

(i) supplying to said engine a lubricant comprising (a) an oil of lubricating viscosity and (b) a succinimide dispersant with a TBN of at least 80 on a diluent-free basis, in an amount sufficient to provide at least 8 TBN to the lubricant;

wherein said lubricant has a zinc content of 0 to 0.07 percent by weight and has a percent sulfated ash value of up to 0.1, a phosphorus content of 50 to 800 ppm and a sulfur content of up to 0.4 percent by weight;

(ii) removing a portion of the lubricant of (i);

(iii) combining the removed portion of (ii) with a major amount of a diesel fuel having a sulfur content of 0 to 50 ppm;

(iv) feeding the combined portion of (iii) into the combustion chamber of said engine, where said combined portion is consumed.

### DETAILED DESCRIPTION OF THE INVENTION

Various preferred features and embodiments will be described below by way of non-limiting illustration.

The present invention provides a composition as described above. The composition has total sulfur content in one embodiment below 0.4 percent by weight, in another embodiment below 0.3 percent by weight, in yet another embodiment 0.2 percent by weight or less and in yet another embodiment 0.1 percent by weight or less. Often the major source of sulfur in the composition of the invention is derived from conventional diluent oil. Typical range for the total sulfur content are 0.01 to 0.1 or 0.4 percent by weight.

Often the composition has a total phosphorus content of less than or equal to 800 ppm, in another aspect equal to or less than 500 ppm, in yet another aspect equal to or less than 300 ppm, in yet another aspect equal to or less than 200 ppm, in yet another aspect equal to or less than 100 ppm and in yet another aspect equal to or less than 50 ppm of the composition. A typical range for the total phosphorus content is 100 to 800 ppm.

Often the composition has a total sulfated ash content as determined by ASTM D-874 of below 0.2 percent by weight, in one embodiment equal to or less than 0.1 percent by weight, in one embodiment equal to or less than 0.07 percent by weight, in yet another embodiment equal to or less than 0.04 percent by weight, in yet another embodiment equal to or less than 0.03 percent by weight and in yet another embodiment equal to or less than 0.05 percent by weight of the composition. A typical range for the total sulfate ash content is 0.05 to 0.2 percent by weight.

The lubricant composition has a total zinc content of 0 to 0.07 percent by weight, in another embodiment 0.01 to 0.05 percent by weight.

Additionally, the aforementioned lubricant composition is a consumable lubricant, in which the composition is feed directly or premixed with fuel and then fed to the combustion engine, wherein the composition does not damage or destroy either the combustion engine or the after-treatment devices. Additionally, the consumable lubricant may aid in the cleaning of the combustion chamber and piston areas of the internal combustion lubricant.

### Oil of Lubricating Viscosity

The low-sulfur, low-phosphorus, low-ash lubricating consumable oil composition comprises one or more base oils which are generally present in a major amount (i.e., an amount greater than about 50 percent by weight). Generally, the base oil is present in an amount greater than about 60 percent, or greater than about 70 percent, or greater than about 80 percent by weight of the lubricating oil composition. The base oil sulfur content is typically less than 0.2 percent by weight.

The low-sulfur, low-phosphorus, low-ash consumable lubricating oil composition may have a viscosity of up to about 16.3 mm²/s (cSt) at 100° C., and in one embodiment 5 to 16.3 mm²/s (cSt) at 100° C., and in one embodiment 6 to 13 mm²/s (cSt) at 100° C. In one embodiment, the lubricating oil composition has an SAE Viscosity Grade of 0W, 0W-20, 0W-30, 0W-40, 0W-50, 0W-60, 5W, 5W-20, 5W-30, 5W-40, 5W-50, 5W-60, 10W, 10W-20, 10W-30, 10W-40 or 10W-50.

The low-sulfur, low-phosphorus, low-ash lubricating oil composition may have a high-temperature/high-shear viscosity at 150° C. as measured by the procedure in ASTM D4683 of up to 4 mm²/s (cSt), and in one embodiment up to 3.7 mm²/s (cSt), and in one embodiment 2 to 4 mm²/s (cSt), and in one embodiment 2.2 to 3.7 mm²/s (cSt), and in one embodiment 2.7 to 3.5 mm²/s (cSt).

The base oil used in the low-sulfur low-phosphorus, low-ash lubricant composition may be a natural oil, synthetic oil or mixture thereof, provided the sulfur content of such oil does not exceed the above-indicated sulfur concentration limit for the inventive low-sulfur, low-phosphorus, low-ash lubricating oil composition. The natural oils that are useful include animal oils and vegetable oils (e.g., castor oil, lard oil) as well as mineral lubricating oils such as liquid petroleum oils and solvent treated or acid-treated mineral lubricating oils of the paraffinic, naphthenic or mixed paraffinic-naphthenic types. Oils derived from coal or shale are also useful. Synthetic lubricating oils include hydrocarbon oils such as polymerized and interpolymerized olefins (e.g., polybutylenes, polypropylenes, propylene isobutylene copolymers, etc.); poly(1-hexenes), poly(1-octenes), poly(1-decenes), etc. and mixtures thereof, alkylbenzenes (e.g., dodecylbenzenes, tetradecylbenzenes, dinonylbenzenes, di-(2-ethylhexyl)benzenes, etc.); polyphenyls (e.g., biphenyls, terphenyls, alkylated polyphenyls, etc.); alkylated diphenyl ethers and the derivatives, analogs and homologs thereof and the like.

Alkylene oxide polymers and interpolymers and derivatives thereof where the terminal hydroxyl groups have been modified by such processes as esterification or etherification constitute another class of known synthetic lubricating oils that can be used. These are exemplified by the oils prepared through polymerization of ethylene oxide or propylene oxide, the alkyl and aryl ethers of these polyoxyalkylene polymers (e.g., methyl-polyisopropylene glycol ether having an average molecular weight of about 1000, diphenyl ether of polyethylene glycol having a molecular weight of about 500-1000, or diethyl ether of polypropylene glycol having a molecular weight of about 1000-1500) or mono- and polycarboxylic esters thereof, for example, the acetic acid esters, mixed C3-8 fatty acid esters, or the carboxylic acid diester of tetraethylene glycol.

Another suitable class of synthetic lubricating oils that can be used comprises the esters of dicarboxylic acids (e.g., phthalic acid, succinic acid, alkyl succinic acids, alkenyl succinic acids, maleic acid, azelaic acid, suberic acid, sebacic acid, fumaric acid, adipic acid, or linoleic acid dimer) with a variety of alcohols (e.g., butyl alcohol, hexyl alcohol, dodecyl alcohol, 2-ethylhexyl alcohol, ethylene glycol, diethylene glycol monoether, or propylene glycol) Specific examples of these esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, and the complex ester formed by reacting one mole of sebacic acid with two moles of tetraethylene glycol and two moles of 2-ethylhexanoic acid.

Esters useful as synthetic oils also include those made from C5 to C12 monocarboxylic acids and polyols and polyol ethers such as neopentyl glycol, trimethylol propane, pentaerythritol, dipentaerythritol, or tripentaerythritol.

The oil can be a poly-alpha-olefin (PAO). Typically, the PAOs are derived from monomers having from 4 to 30, or from 4 to 20, or from 6 to 16 carbon atoms. Examples of useful PAOs include those derived from octene, decene, or mixtures thereof. These PAOs may have a viscosity from 2 to 15, or from 3 to 12, or from 4 to 8 mm²/s (cSt), at 100° C. Examples of useful PAOs include 4 mm²/s (cSt) at 100° C. poly-alpha-olefins, 6 mm²/s (cSt) at 100° C. poly-alpha-olefins, and mixtures thereof. Mixtures of mineral oil with one or more of the foregoing PAOs may be used.

Unrefined, refined and rerefined oils, either natural or synthetic (as well as mixtures of two or more of any of these) of the type disclosed hereinabove can be used in the lubricants of the present invention. Unrefined oils are those obtained directly from a natural or synthetic source without further purification treatment. For example, a shale oil obtained directly from retorting operations, a petroleum oil obtained directly from primary distillation or ester oil obtained directly from an esterification process and used without further treatment would be an unrefined oil. Refined oils are similar to the unrefined oils except they have been further treated in one or more purification steps to improve one or more properties. Many such purification techniques are known to those skilled in the art such as solvent extraction, secondary distillation, acid or base extraction, filtration, percolation, etc. Rerefined oils are obtained by processes similar to those used to obtain refined oils applied to refined oils which have been already used in service. Such rerefined oils are also known as reclaimed or reprocessed oils and often are additionally processed by techniques directed to removal of spent additives and oil breakdown products.

Additionally, oils prepared by hydroisomerization of waxes, (e.g., slack wax or Fischer-Tropsch synthetic wax) are known and can be used.

### The Succinimide Dispersant

The dispersants of the invention are often derived from N-substituted long chain alkenyl succinimides. The invention employs a succinimide dispersant with a high Total Base Number. Generally dispersants with a high TBN number have a nitrogen to carbonyl ratio of at least about 1.4, in one embodiment at least about 1.6, in one embodiment 1.8 or greater, in another embodiment 2.0 or greater. The nitrogen to carbonyl ratio is to be calculated on a molar basis, that is, the ratio of moles of nitrogen functionality (e.g., amine nitrogens) to the moles of carbonyl functionality (e.g., —C(O)O—). In one embodiment, a TBN value is 60, in another embodiment 80, in another embodiment 90 to 100 in yet another embodiment 100 to 110 or 120.

Succinimide dispersants are well known in the field of lubricants and include primarily what are sometimes referred to as “ashless” dispersants because (prior to mixing in a lubricating composition) they do not contain ash-forming metals and they do not normally contribute any ash forming metals when added to a lubricant. Succinimide dispersants are the reaction product of a hydrocarbyl substituted succinic acylating agent with an organic hydroxy compound or, preferably, an amine containing at least one hydrogen attached to a nitrogen atom, or a mixture of said hydroxy compound and amine. The term “succinic acylating agent” refers to a hydrocarbon-substituted succinic acid or succinic acid-producing compound (which term also encompasses the acid itself). Such materials typically include hydrocarbyl-substituted succinic acids, anhydrides, esters (including half esters) and halides.

Succinic based dispersants have a wide variety of chemical structures including typically structures such as

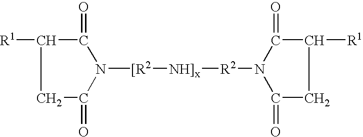

In the above structure, each R¹ is independently a hydrocarbyl group, which may be bound to multiple succinimide groups, typically a polyolefin-derived group having an M̅ₙ of 500 or 700 to 10,000. Typically the hydrocarbyl group is an alkyl group, frequently a polyisobutylene group with a molecular weight of 500 or 700 to 5000, preferably 1500 or 2000 to 5000. Alternatively expressed, the R¹ groups can contain 40 to 500 carbon atoms and preferably at least 50, e.g., 50 to 300 carbon atoms, preferably aliphatic carbon atoms. The R² are alkylene groups, commonly ethylene (C₂H₄) groups. Such molecules are commonly derived from reaction of an alkenyl acylating agent with a polyamine, and a wide variety of linkages between the two moieties is possible beside the simple imide structure shown above, including a variety of amides and quaternary ammonium salts. Succinimide dispersants are more fully described in U.S. Pat. Nos. 4,234,435, 3,172,892, and 6,165,235.

The polyalkenes from which the substituent groups are derived are typically homopolymers and interpolymers of polymerizable olefin monomers of 2 to 16 carbon atoms; usually 2 to 6 carbon atoms.

The olefin monomers from which the polyalkenes are derived are polymerizable olefin monomers characterized by the presence of one or more ethylenically unsaturated groups (i.e., >C=C<); that is, they are mono-olefinic monomers such as ethylene, propylene, 1-butene, isobutene, and 1-octene or polyolefinic monomers (usually diolefinic monomers) such as 1,3-butadiene, and isoprene. These olefin monomers are usually polymerizable terminal olefins; that is, olefins characterized by the presence in their structure of the group >C=CH₂. Relatively small amounts of non-hydrocarbon substituents can be included in the polyolefin, provided that such substituents do not substantially interfere with formation of the substituted succinic acid acylating agents.

Each R¹ group may contain one or more reactive groups, e.g., succinic groups, thus being represented (prior to reaction with the amine) by structures such as

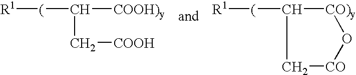

in which y represents the number of such succinic groups attached to the R¹ group. In one type of dispersant, y=1. In another type of dispersant, y is greater than 1, in one embodiment greater than 1.3 or greater than 1.4; and in another embodiment y is equal to or greater than 1.5. in one embodiment y is 1.4 to 3.5, such as 1.5 to 3.5 or 1.5 to 2.5. Fractional values of y, of course, can arise because different specific R¹ chains may be reacted with different numbers of succinic groups.

The amines which are reacted with the succinic acylating agents to form the carboxylic dispersant composition can be monoamines or polyamines. In either case they will be characterized by the formula R⁴R⁵NH wherein R⁴ and R⁵ are each independently hydrogen, hydrocarbon, amino-substituted hydrocarbon, hydroxy-substituted hydrocarbon, alkoxy-substituted hydrocarbon, amino, carbamyl, thiocarbamyl, guanyl, or acylimidoyl groups provided that no more than one of R⁴ and R⁵ is hydrogen. In all cases, therefore, they will be characterized by the presence within their structure of at least one H—N<group. Therefore, they have at least one primary (i.e., H₂N—) or secondary amino (i.e., H—N<) group. Examples of monoamines include ethylamine, diethylamine, n-butylamine, di-n-butylamine, allylamine, isobutylamine, cocoamine, stearylamine, laurylamine, methyllaurylamine, oleylamine, N-methyl-octylamine, dodecylamine, and octadecylamine.

The polyamines from which the dispersant is derived include principally alkylene amines conforming, for the most part, to the formula

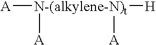

wherein t is an integer typically less than 10, A is hydrogen or a hydrocarbyl group typically having up to 30 carbon atoms, and the alkylene group is typically an alkylene group having less than 8 carbon atoms. The alkylene amines include principally, ethylene amines, hexylene amines, heptylene amines, octylene amines, other polymethylene amines. They are exemplified specifically by: ethylene diamine, diethylene triamine, triethylene tetramine, propylene diamine, decamethylene diamine, octamethylene diamine, di(heptamethylene) triamine, tripropylene tetramine, tetraethylene pentamine, trimethylene diamine, pentaethylene hexamine, di(-trimethylene) triamine. Higher homologues such as are obtained by condensing two or more of the above-illustrated alkylene amines likewise are useful. Tetraethylene pentamine is particularly useful.

The ethylene amines, also referred to as polyethylene polyamines, are especially useful. They are described in some detail under the heading “Ethylene Amines” in Encyclopedia of Chemical Technology, Kirk and Othmer, Vol. 5, pp. 898-905, Interscience Publishers, New York (1950).

Hydroxyalkyl-substituted alkylene amines, i.e., alkylene amines having one or more hydroxyalkyl substituents on the nitrogen atoms, likewise are useful. Examples of such amines include N-(2-hydroxyethyl)ethylene diamine, N,N′-bis(2-hydroxyethyl)-ethylene diamine, 1-(2-hydroxyethyl)piperazine, monohydroxypropyl)-piperazine, di-hydroxypropy-substituted tetraethylene pentamine, N-(3-hydroxypropyl)-tetra-methylene diamine, and 2-heptadecyl-1-(2-hydroxyethyl)-imidazoline.

Higher homologues, such as are obtained by condensation of the above-illustrated alkylene amines or hydroxy alkyl-substituted alkylene amines through amino radicals or through hydroxy radicals, are likewise useful. Condensed polyamines are formed by a condensation reaction between at least one hydroxy compound with at least one polyamine reactant containing at least one primary or secondary amino group and are described in U.S. Pat. No. 5,230,714 (Steckel).

The succinimide dispersant is referred to as such since it normally contains nitrogen largely in the form of imide functionality, although it may be in the form of amine salts, amides, imidazolines as well as mixtures thereof. To prepare the succinimide dispersant, one or more of the succinic acid-producing compounds and one or more of the amines are heated, typically with removal of water, optionally in the presence of a normally liquid, substantially inert organic liquid solvent/diluent at an elevated temperature, generally in the range of 80° C. up to the decomposition point of the mixture or the product; typically 100° C. to 300° C.

The succinic acylating agent and the amine (or organic hydroxy compound, or mixture thereof) are typically reacted in amounts sufficient to provide at least one-half equivalent, per equivalent of acid-producing compound, of the amine (or hydroxy compound, as the case may be). Generally, the maximum amount of amine present will be about 2 moles of amine per equivalent of succinic acylating agent. For the purposes of this invention, an equivalent of the amine is that amount of the amine corresponding to the total weight of amine divided by the total number of nitrogen atoms present. The number of equivalents of succinic acid-producing compound will vary with the number of succinic groups present therein, and generally, there are two equivalents of acylating reagent for each succinic group in the acylating reagents. Additional details and examples of the procedures for preparing the succinimide dispersants of the present invention are included in, for example, U.S. Pat. Nos. 3,172,892; 3,219,666; 3,272,746; 4,234,435; 6,440,905 and 6,165,235.

The dispersants may be borated materials. Borated dispersants are well-known materials and can be prepared by treatment with a borating agent such as boric acid. Typical conditions include heating the dispersant with boric acid at 100 to 150° C. The dispersants may also be treated by reaction with maleic anhydride as described in WO00/26327.

In one embodiment, the amount of the succinimide dispersant in a completely formulated consumable lubricant will typically be 2.0 to 20 percent by weight; in another embodiment, 4 to 16 percent by weight or 6 to 14 percent by weight, or 7 to 10 percent by weight. Its concentration in a concentrate will be correspondingly increased to, e.g., 15 to 80 weight percent.

### Fuel

The fuel may be a diesel fuel. These include hydrocarbonaceous petroleum distillate fuels such as diesel fuel as defined by ASTM Specification D396. Normally liquid diesel fuels containing materials such as alcohols, ethers, and organo-nitro compounds (e.g., methanol, ethanol, diethyl ether, methyl ethyl ether, nitromethane) are also within the scope of this invention as are liquid fuels derived from vegetable or mineral sources such as corn, alfalfa, shale and coal. Examples of such mixtures include diesel fuel and ether.

The diesel fuel that is useful is a low-sulfur diesel fuel. These diesel fuels typically have a 90% point distillation temperature in the range of 300° C. to 390° C., and in one embodiment 330° C. to 350° C. The viscosity for these fuels typically ranges from about 1.3 to 24 centistokes at 40° C. The diesel fuels can be classified as any of Grade Nos. 1-D, 2-D or 4-D as specified in ASTM D975. These diesel fuels may contain alcohols and esters. In particular the diesel fuel is a diesel fuel termed ultra low sulfur diesel (ULSD), which has a maximum 50 parts per million (ppm) sulfur content and a 95% distillation temperature of less than 345° C. as determined by the test method specified in ASTM D2622-87. A typical range for the sulfur content of the fuel is 0 to 50 ppm or 1 to 30 ppm or 2 to 15 ppms.

The fuel compositions may contain one or more fuel additives known in the art for enhancing the performance of the fuel. These include deposit preventers or modifiers, dyes, cetane improvers, antioxidants such as 2,6-di-tertiary-butyl-4-methyl-phenol, corrosion inhibitors such as alkylated succinic acids and anhydrides, bacteriostatic agents, gum inhibitors, metal deactivators, demulsifiers, upper cylinder lubricants, anti-icing agents, and ashless dispersants.

The fuel additives may be added directly to the fuel, or they may be diluted with a normally liquid organic diluent such as naphtha, benzene, toluene, or xylene to form an additive concentrate prior to addition to the fuel. These concentrates typically contain 10% to 90% by weight diluent.

### The Internal Combustion Engine

The internal combustion engine may be a spark-ignited or a compression-ignited engine. These engines include automobile and truck engines, two-cycle engines, aviation piston engines, and marine and railroad diesel engines. Included are on- and off-highway engines. The compression-ignited engines include those for both mobile and stationary power plants. The compression-ignited engines include those used in urban buses, as well as all classes of trucks. The compression-ignited engines may be of the two-stroke per cycle or four-stroke per cycle type. The compression-ignited engines include heavy duty diesel engines for both mobile (including marine) and stationary power plants. These include diesel engines of the two-stroke per cycle and four-stroke per cycle types, on and off-highway engines, including new engines as well as in-use engines, automobiles, trucks, buses, and locomotives.

### After Treatment Device

The exhaust gas after treatment device may be referred to as a catalytic converter and may be of any conventional design. The exhaust after treatment device may comprise flow-through passages of ceramic or metal coated with a washcoat comprised of zeolite, Al₂O₃, SiO₂, TiO₂, CeO₂, ZrO₂, V₂O₅, La₂O₃, or mixtures of two or more thereof, the washcoat supporting a catalyst selected from the group consisting of Pt, Pd, Rh, Ir, Ru, V, Cr, Mn, Fe, Co, Ni, Cu, Zn, Ag, Ce, Ga, or a mixture of two or more thereof. In one embodiment the after treatment device is diesel particulate filter (DPF) containing diesel oxidation catalyst (DOC). The DPF's are essentially fine porous filters used to trap small particulate matter from the combustion chamber, while the DOC's are precious metals, such as platinum or palladium, that act as catalytic material on the diesel particulate filter in reducing toxic emissions.

### Exhaust Gas Recirculation

Exhaust gas recirculation (EGR) is a technique that directs the exhaust back into the air intake. Because these gases have already been used by the engine, they have a lower oxygen level. By reducing the oxygen level in the air intake there is less oxygen available to allow nitrogen oxides to form. The exhaust gas in the air intake also absorbs more energy during the combustion process, which lowers the peak in cylinder gas temperature and also helps to lower the level of NOx (high temperatures are needed for NOx formation).

### Miscellaneous

Antioxidants (that is, oxidation inhibitors), may be used which including hindered phenolic antioxidants such as 2,6,-di-t-butylphenol, and hindered phenolic esters such as the type represented by the following formula:

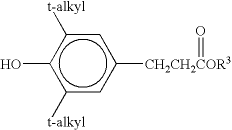

and in a specific embodiment,

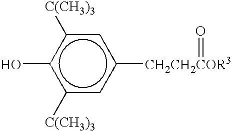

wherein R³ is a straight chain or branched chain alkyl group containing 2 to 10 carbon atoms, in one embodiment 2 to 4, and in another embodiment 4 carbon atoms. In one embodiment, R³ is an n-butyl group. In another embodiment R³ can be 8 carbons, as found in Irganox L-135™ from Ciba. The preparation of these antioxidants can be found in U.S. Pat. No. 6,559,105.

Further antioxidants can include secondary aromatic amine antioxidants such as dialkyl (e.g., dinonyl) diphenylamine, sulfurized phenolic antioxidants, oil-soluble copper compounds, phosphorus-containing antioxidants, molybdenum compounds such as the Mo dithiocarbamates, organic sulfides, disulfides, and polysulfides (such as sulfurized Diels Alder adduct of butadiene and butyl acrylate). An extensive list of antioxidants is found in U.S. Pat. No. 6,251,840.

The EP/antiwear agent used in connection with the present invention is typically in the form of a phosphorus ester of the formula (R¹X)(R²X)P(X)ₙXₘR³ or an amine salt thereof, where each X is independently an oxygen atom or a sulfur atom, n is 0 or 1, m is 0 or 1, m+n is 1 or 2, and R¹, R², and R³ are hydrogen or hydrocarbyl groups. At least one of R¹, R², and R³ is a hydrocarbyl group, and in one embodiment at least one is hydrogen. This component thus includes phosphite esters, phosphate esters, and thiophosphite and thiophosphate esters. The esters can be mono-, di- or tri-hydrocarbyl esters. It is noted that certain of these materials can exist in tautomeric forms, and that all such tautomers are intended to be encompassed by the above formula and included within the present invention. For example certain phosphite esters can be written in at least two ways, (RO)₂—PH(═O) and (RO)₂—P—OH , differing merely by the placement of the hydrogen. Each of these structures is intended to be encompassed by the present invention.

The total number of carbon atoms in R¹, R² and R³ in each of the above formula (for the phosphorus compound) should be sufficient to render the compound soluble in the medium. Generally, the total number of carbon atoms in R¹, R² and R³ is at least 8, and in one embodiment at least 12, and in one embodiment at least 16. There is no limit to the total number of carbon atoms in R¹, R² and R³ that is required, but a practical upper limit is 400 or 500 carbon atoms. In one embodiment, R¹, R² and R³ in the above formula are independently hydrocarbyl groups of preferably 1 to 100 carbon atoms, or 1 to 50 carbon atoms, or 1 to 30 carbon atoms. Each R¹, R² and R³ can be the same as the other, although they may be different. Examples of useful R¹, R² and R³ groups include hydrogen, n-butyl, isobutyl, amyl, isooctyl, decyl, dodecyl, oleyl, C₁₈ alkyl, eicosyl, 2-pentenyl, dodecenyl, phenyl, naphthyl, alkylphenyl, alkylnaphthyl, phenylalkyl, naphthylalkyl, alkylphenylalkyl, and alkylnaphthylalkyl.

In one embodiment at least two of the X atoms in the above structure are oxygen, so that the structure will be (R¹O)(R²O)P(X)ₙXₘR³. In one embodiment R¹, R² and R³ are all aryl and all X's are O.

The R¹ and R² groups can comprise a mixture of hydrocarbyl groups derived from commercial alcohols. Examples of some preferred monohydric alcohols and alcohol mixtures include the commercially available Alfol™ alcohols marketed by Continental Oil Corporation. Alfol™ 810, for instance, is a mixture containing alcohols consisting essentially of straight-chain primary alcohols having from 8 to 10 carbon atoms. Another commercially available alcohol mixture is Adol™ 60 which comprises about 75% by weight of a straight-chain C₂₂ primary alcohol, about 15% of a C₂₀ primary alcohol, and about 8% of C₁₈ and C₂₄ alcohols. The Adol™ alcohols are marketed by Ashland Chemical.

A variety of mixtures of monohydric fatty alcohols derived from naturally occurring triglycerides and ranging in chain length from C₈ to C₁₈ are available from Procter & Gamble Company. Another group of commercially available mixtures include the Neodol™ products available from Shell Chemical Co. Other alcohols which can be used are lower molecular weight alcohols such as methanol, ethanol, propanol, isopropanol, normal butanol, isobutanol, tert-butanol, the pentanols, hexanols, heptanols, octanols (including 2-ethyl hexanol), nonanols, decanols, and mixtures thereof.

The dihydrocarbyl hydrogen phosphites, such as dibutyl hydrogen phosphite, useful in this invention can be prepared by techniques well known in the art, and many such phosphites are available commercially.

In one embodiment, the phosphorus-containing agent is a hydrocarbyl phosphate. In another embodiment, the hydrocarbyl phosphate can be a hydrocarbyl thiophosphate. In yet another embodiment, the phosphorus compound can be a phosphorus-containing amide, such as the reaction product of dithiophosphoric acid and acrylamide or methylene bis-acrylamide.

Examples of phosphorus-containing materials are phosphites and phosphates such as dibutyl phosphite, diphenylphosphite, triphenylphosphite, tricresylphosphate and triphenylthiophosphate.

The amount of phosphorus ester or amine salt present is typically enough to deliver up to 0.05 percent by weight of phosphorus to the composition, in one embodiment 0.002 to 0.01 percent by weight of phosphorus and in another embodiment 0.005 to 0.05 percent by weight of phosphorus. A 0.05 percent by weight phosphorus package corresponds to a typical phosphorus ester level of 0.5 percent by weight in a finished fluid formulation.

The role of the corrosion inhibitor in this invention is to preferentially adsorb onto metal surfaces to provide protective film, or to neutralize corrosive acids. Examples of these include, but are not limited to polyether derived from an ethylene oxide-propylene oxide copolymer, ethoxylates, alkenyl succinic half ester acids, zinc dithiophosphates, metal phenolates, basic metal sulfonates, fatty acids and amines.

Anti-foam agents can be used to reduce or prevent the formation of stable foam include silicones or organic polymers. Examples of these and additional anti-foam compositions are described in “Foam Control Agents”, by Henry T. Kerner (Noyes Data Corporation, 1976), pages 125-162.

Pour point depressants can be used to improve the low temperature properties of oil-based compositions. See, for example, page 8 of “Lubricant Additives” by C. V. Smalheer and R. Kennedy Smith (Lezius Hiles Co. publishers, Cleveland, Ohio, 1967). Examples of useful pour point depressants are polymethacrylates; dispersant-polymethacrylates; polyacrylates; polyacrylamides; condensation products of haloparaffin waxes and aromatic compounds; ethylene vinyl carboxylate copolymers; and terpolymers of dialkylfumarates, vinyl esters of fatty acids and alkyl vinyl ethers. Pour point depressants are described in U.S. Pat. Nos. 2,387,501; 2,015,748; 2,655,479; 1,815,022; 2,191,498; 2,666,746; 2,721,877; 2,721,878; and 3,250,715.

An additional type of pour point depressant is an esterified polymer of maleic anhydride and styrene. These pour point depressant are esters obtained by copolymerizing styrene and maleic anhydride in the presence of a free radical initiator and thereafter esterifying the copolymer with a mixture of C4-18 alcohols also are useful as viscosity modifying additives. The styrene esters generally are considered to be multi-functional premium viscosity modifiers. The styrene esters in addition to their viscosity-modifying properties also are pour point depressants and exhibit dispersancy properties when the esterification is terminated before its completion leaving some unreacted anhydride or carboxylic acid groups. These acid groups can then be converted to imides by reaction with a primary amine.

The compositions of the present invention are employed in practice as lubricants by supplying the lubricant to an internal combustion engine (such as a stationary gas-powered internal combustion engine or a heavy duty diesel engine) in such a way that during the course of operation of the engine the lubricant is delivered to the critical parts of the engine, thereby lubricating the engine. A portion of the present invention used in the engine collects in the oil sump and is pumped form the oil to the fuel system, where it is combined with the fuel and then consumed by the engine. The introduction of the present invention into the fuel may occur in one or more of the fuel tank, fuel return line, fuel injectors, intake manifold, positive crankcase ventilation system, exhaust gas recirculation system, intake and/or exhaust valve guides, or the air intake system of the engine. The sequence of removing used oil from the engine and replacing it with new oil may be performed continuously or intermittently during the operation of the engine. The amount of the lubricant of the present invention consumed by the engine may be replenished by adding a comparable amount of the lubricant of the present invention to the engine.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include: hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring); substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy); hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### EXAMPLE

Example 1 (invention) and Example 2 (comparative) (see the formulations in Table 1) are tested in the Modified Caterpillar™ 1P test. The duration of the test is 288 hours and test engines are run under the following conditions: a speed of 1800 rpm, power of 50 kW, torque 263 Nm, coolant out 90° C., oil 130° C. and air inlet 60° C. The results of the test can be found in Table 2.

TABLE 1
Formulations

| Example 1 (invention) | | Example 2 (comparative) | |
|---|---|---|---|
| Components (oil free basis) | wt. % | Components (oil free basis) | wt. % |
| Base Oil: Polyalphaolefin | 85.29 | Mineral Oil | |
| Dispersant: Succinimide de- | 7.8 | Conventional Engine Oil | |
| rived from the condensation | | Additive Package | |
| product of polyisobutylene | | | |
| (number average molecular | | | |
| weight (Mn) equal to about | | | |
| 1000) with tetraethylene | | | |
| pentamine, with a carbonyl | | | |
| to nitrogen ratio of | | | |
| about 0.6 | | | |
| Pour point depressant | 0.3 | | |
| Amine antioxidant | 0.7 | | |
| Phosphorus anti-wear agent | 0.3 | | |
| Phenol antioxidant | 0.3 | | |
| Polyether corrosion inhibitor | 0.02 | | |
| Ester copolymer anti-foam | 0.09 | | |
| agent | | | |
| Chemical Analysis | | | |
| Calcium (%) | ~0 | | 0.291 |
| Phosphorus (%) | 0.01 | | 0.120 |
| Sulfur (%) | 0.03 | | 0.440 |
| Zinc (%) | ~0 | | 0.135 |
| Sulfated Ash (%) | <0.1 | | 1.2 |

TABLE 2

| | Example 1 | Example 2 |
|---|---|---|
| Test Results | (invention) | (comparative) |
| Upper Piston Deposit | Pass (21.75) | Fail (48) |
| (value >40 is a fail) | | |
| Wear Metals (ppm of Fe) | 31 | 89 |
| Oil Consumption (grams/ | 4.8 | 7.6 |
| hr) | | |
| Particulate Matter | 0.0027 | 0.0038 |
| Reduction (grams) | | |

The results illustrate the advantages of the inventive lubricant composition, which include providing a consumable lubricant which reduces deposit formation, decreases wear in the engine, lowers oil consumption and reduces the formation of particulate matter.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

What is claimed is:

1-12. (canceled)

13. A method of operating an internal combustion engine, comprising:
(i) supplying to said engine a lubricant comprising (a) an oil of lubricating viscosity and (b) a succinimide dispersant with a TBN of at least 80 on a diluent-free basis, in an amount sufficient to provide at least 8 TBN to the lubricant; wherein said lubricant has a zinc content of 0 to about 0.05 percent by weight and has a percent sulfated ash value of up to about 0.2, a phosphorus content of about 50 to about 800 ppm and a sulfur content of up to about 0.4 percent by weight;
(ii) removing a portion of the lubricant of (i);
(iii) combining the removed portion of (ii) with a major amount of a diesel fuel having a sulfur content of 0 to about 50 ppm;
(iv) feeding the combined portion of (iii) into the combustion chamber of said engine, where said combined portion is consumed.

14. The method of claim 13, wherein a portion of the lubricant is consumed during operation of said engine and an additional amount is added to said engine to replace said consumed lubricant.

15. The method of claim 13, wherein the internal combustion engine is equipped with exhaust gas recirculation.

16. The method of claim 13, wherein the internal combustion engine is a heavy duty diesel engine.

17. The method of claim 16, wherein the heavy duty diesel further comprises an exhaust after treatment device.

18. The method of claim 13, wherein the removed lubricant portion of (ii) is combined with the diesel fuel in the fuel tank, fuel return line, fuel injectors, intake manifold, positive crankcase ventilation system, exhaust gas recirculation system, intake and/or exhaust valve guides, air intake system or combinations thereof.
